(19) United States
(12) Patent Application Publication
(10) Pub. No.: US 2016/0236309 A1
(43) Pub. Date: Aug. 18, 2016

(54) ROTARY TABLE

(71) Applicant: Anchor Mechatronics Inc., Taipei City (TW)

(72) Inventor: Feng-Tien CHEN, Taichung City (TW)

(21) Appl. No.: 14/942,590

(22) Filed: Nov. 16, 2015

(30) Foreign Application Priority Data
Feb. 13, 2015 (TW) 104202515

(51) Int. Cl. B23Q 3/04; B23Q 3/18; B23Q 3/12

(52) U.S. Cl. CPC B23Q 3/04; B23Q 3/12; B23Q 3/18

(57) ABSTRACT

A rotary table is adapted to drive rotation of a fixture, and includes first and second mounting seats, first and second spindles respectively disposed in the first and second mounting seats, and a motor unit including main and auxiliary driving motors. The motor unit is operable in a first mode, where the main driving motor directly drives rotation of the first spindle and the auxiliary driving motor is not actuated, and in a second mode, where the auxiliary driving motor cooperates with the main driving motor to drive rotation of the first and second spindles so as to deliver a torque which is larger than that delivered in the first mode to the fixture to drive rotation of the fixture.

### CROSS-REFERENCE TO RELATED APPLICATION

This application claims priority of Taiwanese Patent Application No. 104202515, filed on Feb. 13, 2015.

### FIELD

The disclosure relates to a rotary table, more particularly to a rotary table adapted for use in a computer numerical control machine.

### BACKGROUND

Rotary table is a main component of a computer numerical control machine, and is a positioning device used when performing machining operation, such as drilling, milling, circular or linear cutting, etc., on a work piece. Rotary table can be used with index plates so as to position the work piece at a precise angle relative to the CNC machine or enable rotation of the work piece at desired time interval. For example, Taiwanese Utility Model Patent No. M492217 discloses a conventional rotary table, which includes a mounting seat defining a space, a driving shaft mounted to the mounting seat, an indexing plate fixedly connected to an end of the driving shaft and holding a work piece in place, a worm disposed in the space and connected to the driving shaft, a worm gear disposed in the space and meshing with the worm, and a driving motor mounted to the mounting seat. The driving motor is operable to rotate of the worm so as to drive rotation of the indexing plate via the worm gear. However, wear of the worm and the worm gear due to frequent or long-term usage may lead to backlash, which may adversely affect rotation of the indexing plate and may affect precision in indexing. Furthermore, dimensional tolerances of the worm and the worm gear may also affect the precision in indexing.

Taiwanese Utility Model Patent Publication No. 200930495 discloses another conventional rotary table that includes an indexing plate and a direct drive motor co-axially and directly connected to the indexing plate so as to directly drive rotation of the indexing plate. The direct drive motor includes an electromagnetic coil and a magnetic component. Since a fixture used with the conventional rotary table may be relatively large and heavy, a sufficient number of turns of the electromagnetic coil and a relatively strong magnetic field produced by the magnetic component are required to supply an adequate amount of torque to the fixture, thereby undesirably increasing the size and complexity of such conventional rotary table. Such conventional rotary table has higher manufacturing costs, is relatively difficult to perform maintenance and repair operations, and may interfere with the machining operation of the work piece. Moreover, since rotational speed of the fixture decreases with an increase in torque delivered to the fixture in a case where the same power output of the driving motor is transmitted, a relatively high rotational speed may be hard to achieve or maintain.

### SUMMARY

Therefore, an object of the disclosure is to provide a rotary table that can alleviate at least one of the aforesaid drawbacks of the prior arts.

According to one aspect of the disclosure, the rotary table is adapted for use in a computer numerical control machine that includes a fixture to drive rotation of the fixture. The fixture has opposite first and second ends. The rotary table includes a first mounting seat, a first spindle, a second mounting seat, a second spindle and a motor unit.

The first mounting seat defines a first space. The first spindle is disposed in the first space, is rotatable about an axis, and is securely connected to the first end of the fixture. The second mounting seat is spaced apart from the first mounting seat along the axis and defines a second space. The second spindle is disposed in the second space, is rotatable about the axis, and is securely connected to the second end of the fixture. The motor unit includes a main driving motor that is directly connected to the first spindle so as to directly drive rotation of the first spindle, and an auxiliary driving motor that is for driving rotation of the second spindle.

The motor unit is operable in a first mode, where the main driving motor drives rotation of the first spindle and the auxiliary driving motor does not drive rotation of the second spindle, and in a second mode, where the auxiliary driving motor cooperates with the main driving motor to drive rotation of the first and second spindles so as to deliver a torque which is larger than that delivered in the first mode to the fixture to drive rotation of the fixture.

According to another aspect of the disclosure, the rotary table is adapted for use in a computer numerical control machine that includes a fixture. The rotary table includes a mounting seat, a spindle and a motor unit.

The mounting seat defines a space. The spindle is disposed in the space, is rotatable about an axis, and is adapted to be securely connected to an end of the fixture. The motor unit includes a main driving motor that is directly connected to the spindle so as to directly drive rotation of the spindle, and an auxiliary driving motor that is for driving rotation of the spindle.

The motor unit is operable in a first mode, where the main driving motor drives rotation of the spindle and the auxiliary driving motor does not drive rotation of the spindle, and in a second mode, where the auxiliary driving motor cooperates with the main driving motor to drive rotation of the spindle so as to deliver a torque which is larger than that delivered in the first mode to the fixture to drive rotation of the fixture.

### BRIEF DESCRIPTION OF THE DRAWINGS

Other features and advantages of the disclosure will become apparent in the following detailed description of the exemplary embodiments with reference to the accompanying drawings, of which:

FIG. 1 is a perspective view of a CNC machine including a fixture and a first exemplary embodiment of a rotary table according to the disclosure;

FIG. 2 is a partly sectional view illustrating the fixture and the first exemplary embodiment;

FIG. 3 is a schematic view illustrating a motor unit of the first exemplary embodiment of the rotary table being driven by a control system;

FIG. 4 is a perspective view of the CNC machine including a modified fixture and the first exemplary embodiment;

FIG. 5 is a partly sectional view illustrating the modified fixture and the first exemplary embodiment;

FIG. 6 is a perspective view of a CNC machine including a fixture and a second exemplary embodiment of the rotary table according to the disclosure; and

FIG. 7 is a partly sectional view illustrating the fixture and the second exemplary embodiment;

FIG. 8 is a perspective view of a CNC machine including a third exemplary embodiment of the rotary table according to the disclosure; and

FIG. 9 is a partly sectional top view illustrating the third exemplary embodiment and a tailstock.

### DETAILED DESCRIPTION

Before the disclosure is described in greater detail, it should be noted that like elements are denoted by the same reference numerals throughout the disclosure.

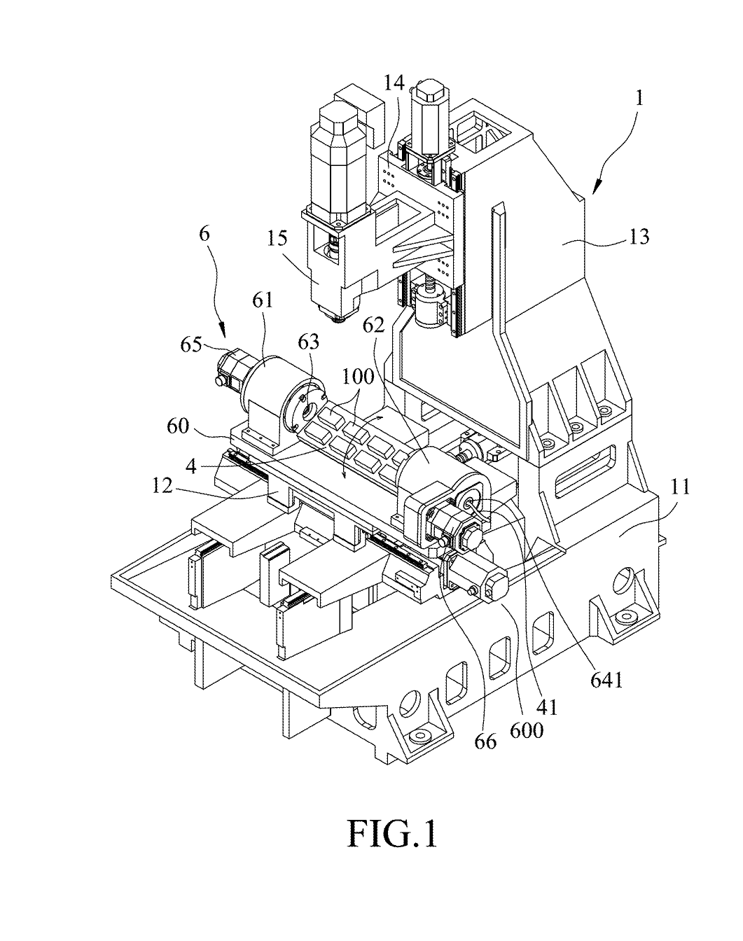

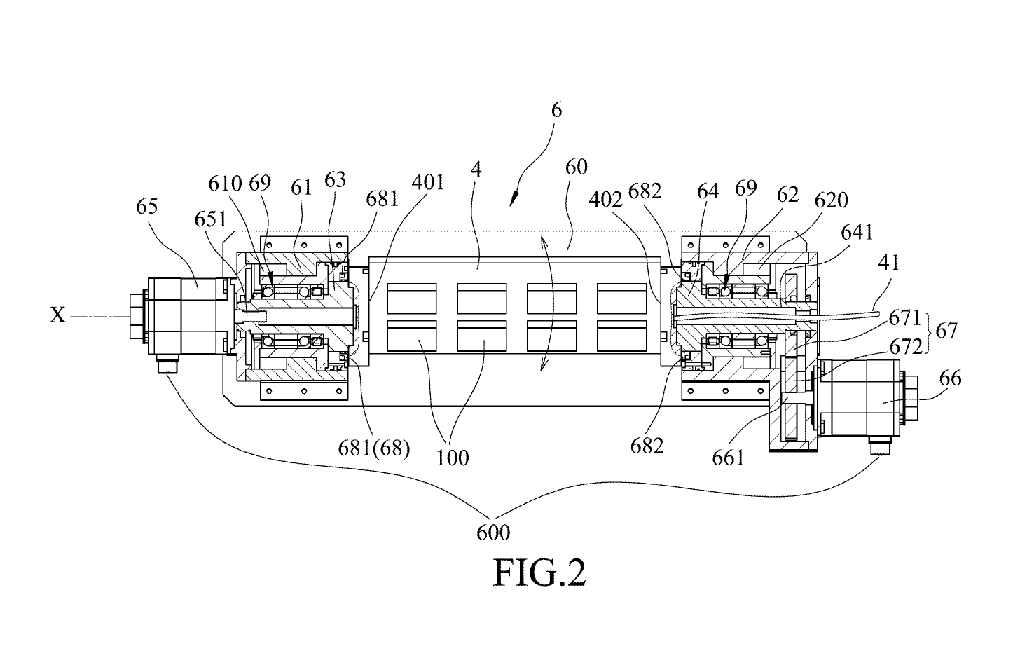

Referring to FIGS. 1 to 2, a first exemplary embodiment of a rotary table 6 according to the disclosure is adapted for use in a computer numerical control (CNC) machine 1 that includes a fixture 4. The rotary table 6 is adapted to drive rotation of the fixture 4, which has opposite first and second ends 401, 402 and on which a plurality of work pieces 100 are mounted. The CNC rotary machine 1 includes a bed 11, a support post 13 extends upwardly from the bed 11, a slidable stage 14 mounted on the support post 13 and slidable in a vertical direction, a processing tool 15 mounted to the slidable stage 14, and a worktable 12, which is disposed on the bed 11, which is movable in a horizontal direction, and on which the rotary table 6 is disposed.

The rotary table 6 of the first exemplary embodiment includes a base 60, a first mounting seat 61, a second mounting seat 62, a first spindle 63, a second spindle 64, a motor unit 600, a gear set 67, a brake unit 68 and two bearings 69. The base 60 is securely mounted on the worktable 12.

The first mounting seat 61 is fixedly disposed on the base 60 and defines a first space 610. The second mounting seat 62 is fixedly disposed on the base 60, is spaced apart from the first mounting seat 61 along an axis (X), and defines a second space 620. The first spindle 63 is disposed in the first space 610, is rotatable about the axis (X), and is securely connected to the first end 401 of the fixture 4 . The second spindle 64 is disposed in the second space 620, is rotatable about the axis (X), and is securely connected to the second end 402 of the fixture 4. In this embodiment, the second spindle 64 is formed with a through hole 641 that extends along the axis (X) and that is adapted for an electrical cable 41 of the fixture 4 to extend therethrough.

Each of the first and second spindles 63, 64 has a stepped-shaped longitudinal section (see FIG. 2). The first and second spindles 63, 64 are securely and respectively disposed in the first and second mounting seats 61, 62 by virtue of the respective bearings 69.

The motor unit 600 includes a main driving motor 65 and an auxiliary driving motor 66. The main driving motor 65 is mounted to the first mounting seat 61, and includes a first output shaft 651 co-axially and directly connected to the first spindle 63 so as to directly drive rotation of the first spindle 63. The auxiliary driving motor 66 is mounted to the second mounting seat 62, and includes a second output shaft 661 parallel to and spaced apart from the second spindle 64 in a horizontal direction perpendicular to the axis (X).

The gear set 67 is disposed in the second space 620, and includes a first gear 671 and a second gear 672. The first gear 671 is securely connected to and co-rotatable with the second spindle 64. The second gear 672 meshes with the first gear 671, is connected to and co-rotatable with the second output shaft 661, and is driven by the auxiliary driving motor 66 to enable rotation of the second spindle 64 via the first gear 671. In this embodiment, the speed ratio of the second gear 672 to the first gear 671 is 1:1 so as to permit the first and second spindles 63, 64 to rotate at the same rotational speed.

The brake unit 68 includes a plurality of first and second braking members 681, 682. The first braking members 681 are disposed in the first mounting seat 61, are angularly spaced apart and surround the first spindle 63, and are operable to press against an outer surface of the first spindle 63 so as to arrest rotation of the first spindle 63. The second braking members 682 are disposed in the second mounting seat 62, are angularly spaced apart and surround the second spindle 64, and are operable to press against an outer surface of the second spindle 64 so as to arrest rotation of the second spindle 64. Since operation of the brake unit 68 is not the main feature of the disclosure, further details of the same will not be provided herein for the sake of brevity.

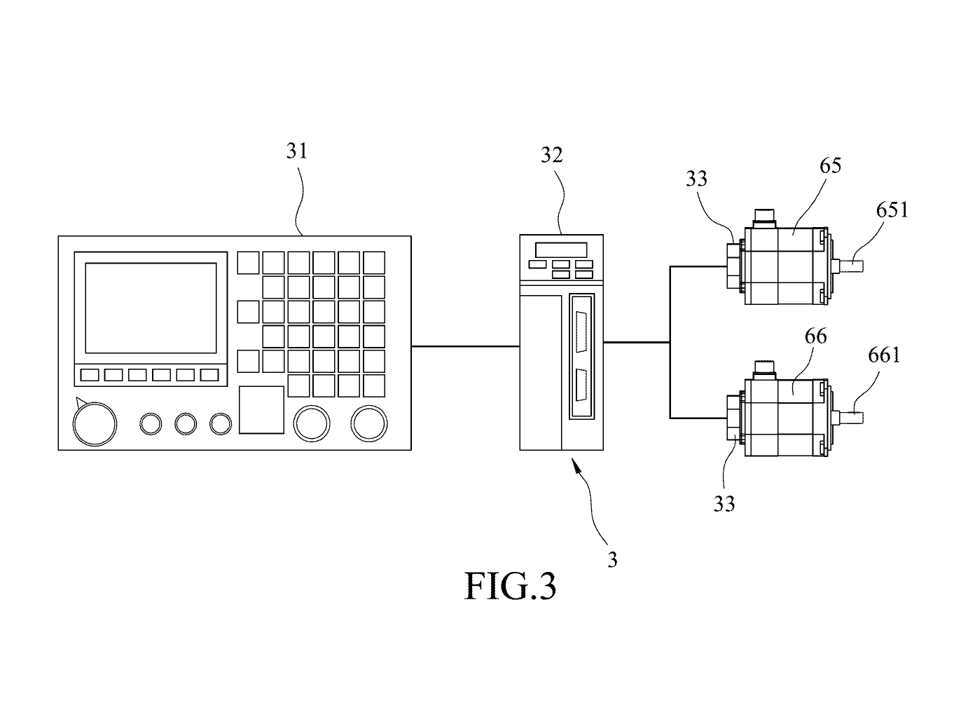

Referring to FIGS. 2 and 3, the first and second output shafts 651, 661 are controlled and driven by a control system 3 that includes a motion controller 31, a servo driver 32 and two optical encoders 33. The motion controller 31 and the servo driver 32 control rotation of the first and second output shafts 651, 661. The optical encoders 33 are respectively connected to the first and second output shafts 651, 661 to obtain real-time position signals indicative of exact rotation angles of the first and second output shafts 651, 661 and output the position signals to the motion controller 31. In response to reception of the position signals, the motion controller 31 modifies a command that includes rotation parameters for controlling rotation of the first and second output shafts 651, 661, and that is sent to the servo driver 32, so that the servo driver 32 drives rotation of the first and second output shafts 651, 661 based on the command. As such, the rotation angles of the first and second output shafts 651, 661 are precisely controlled.

The motor unit 600 is operable in a first mode, where the main driving motor 65 drives rotation of the first spindle 63 to rotate the fixture 4, and the auxiliary driving motor 66 does not drive rotation of the second spindle 64, and in a second mode, where the auxiliary driving motor 66 cooperates with the main driving motor 65 to drive rotation of the first and second spindles 63, 64 so as to deliver a torque which is larger than that delivered in the first mode to the fixture 4 to drive rotation of the fixture 4.

In this embodiment, the main driving motor 65 directly drives rotation of the first output shaft 651 in the first mode. When a relatively large amount of torque is required to drive the rotation of the fixture 4, the auxiliary driving motor 66 is actuated to drive rotation of the second spindle 64 via the gear set 67 so that a relatively large torque is delivered to the fixture 4 in the second mode.

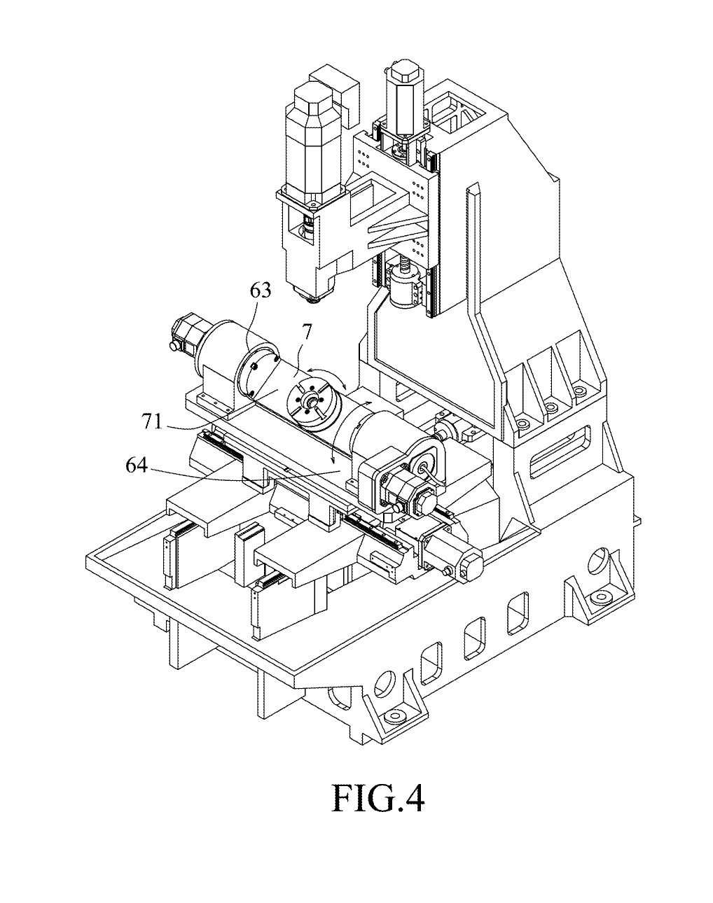

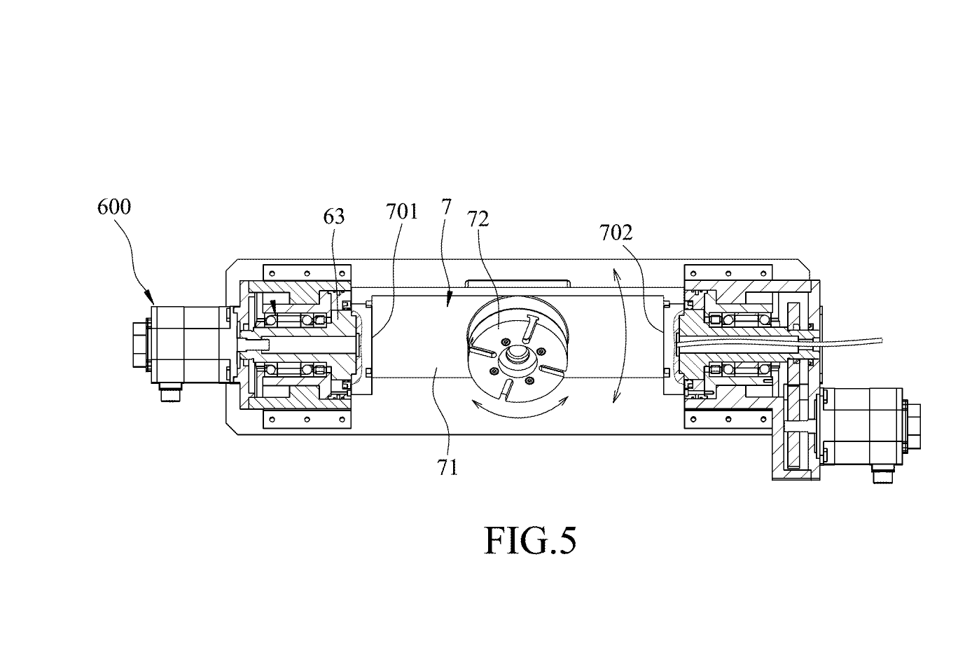

It should be noted that the configuration of the fixture 4 used is not restricted to that shown in FIGS. 1 and 2. For example, as shown in FIGS. 4 and 5, the fixture 4 may be configured as a jig 7 that includes a main body 71 having two opposite ends 701, 702 respectively connected to the first and second spindles 63, 64, and a rotatable disc 72, which is mounted on the center of the main body 71 and on which a work piece (not shown) is mounted. The work piece can be rotated in two directions as indicated by the arrows in FIG. 5.

To sum up, a precise positioning or indexing operation of the CNC machine can be ensured since rotation of the fixture 4 is mainly and directly driven by the main driving motor 65. Additionally, the auxiliary driving motor 66 delivers additional torque to the fixture 4 when a relatively large torque is needed for driving rotation of the fixture 4. Moreover, servo motors that are commercially available in market can be used as the main driving motor 65 and the auxiliary driving motor 66. As a result, the rotary table 6 of the disclosure has relatively low manufacturing costs, and is relatively easy to assemble and repair as compared with the conventional rotary table disclosed in Taiwanese Utility Model Patent Publication No. 200930495.

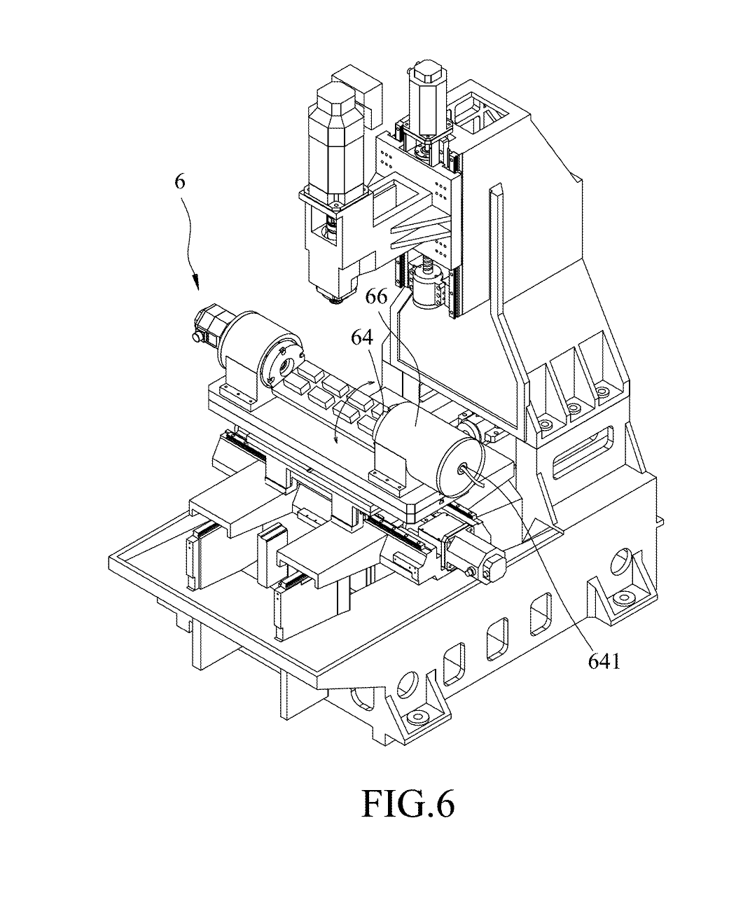

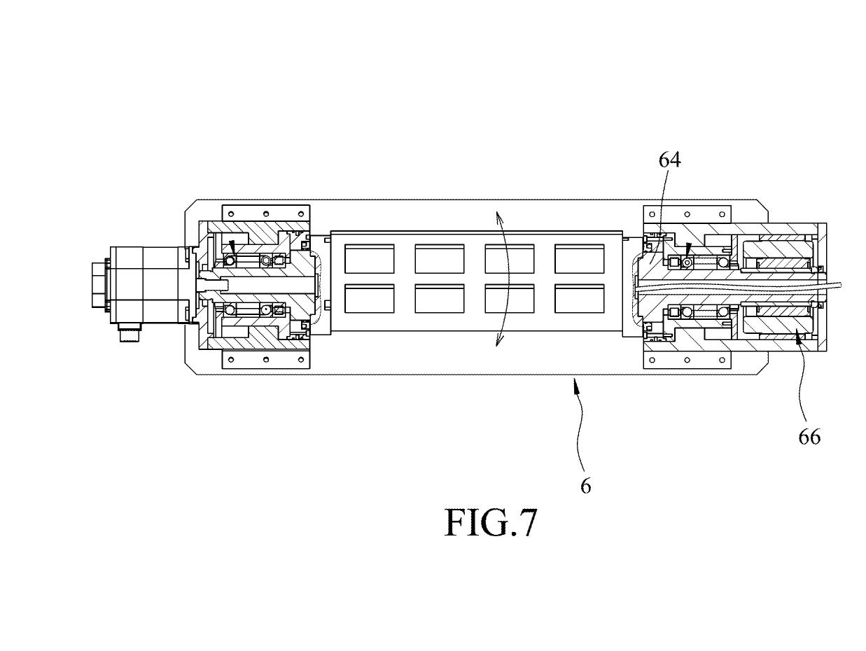

Referring to FIGS. 6 and 7, a second exemplary embodiment of the rotary table 6 according to the disclosure is similar to the first exemplary embodiment. The difference between the first and second exemplary embodiments resides in that the gear set 67 (see FIG. 2) of the first exemplary embodiment is omitted in the second exemplary embodiment, and the auxiliary driving motor 66 is directly connected to the second spindle 64 so as to directly drive rotation of the second spindle 64.

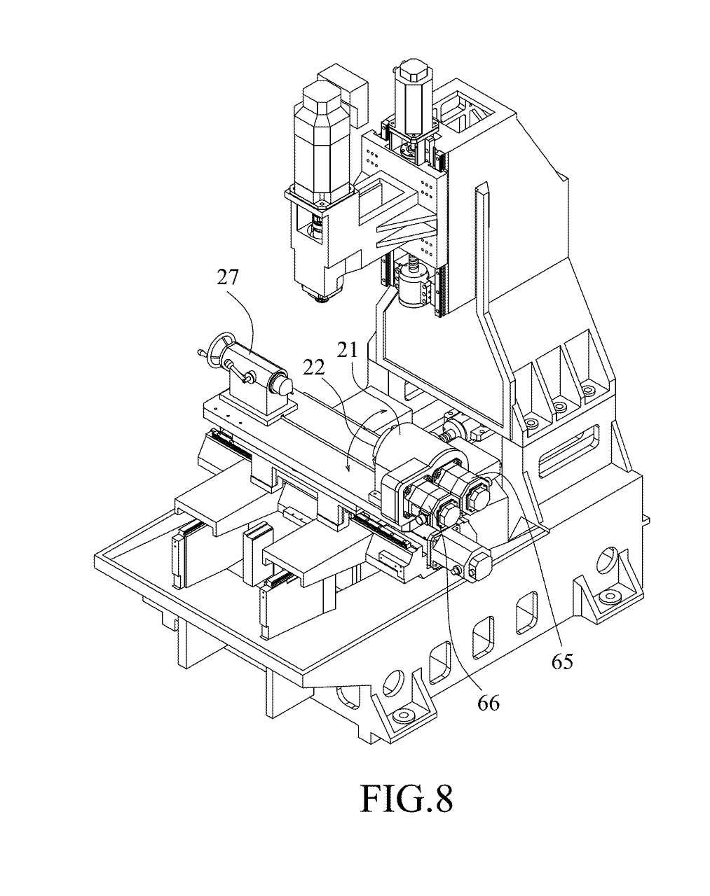

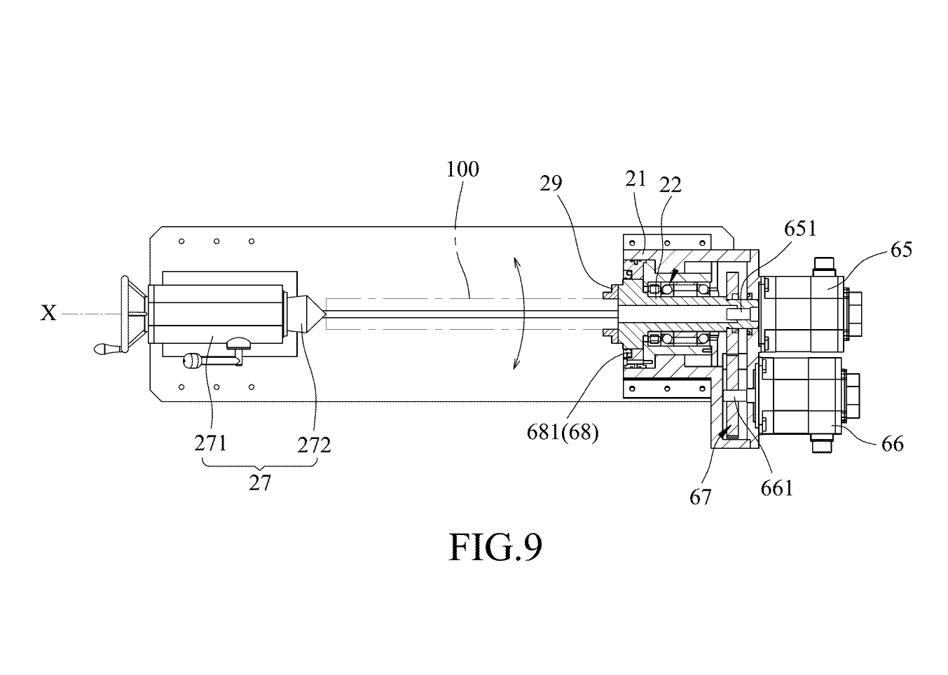

Referring to FIGS. 8 and 9, a third exemplary embodiment of the rotary table 6 according to the disclosure is similar to the first exemplary embodiment. The difference between the first and third exemplary embodiments resides in that the rotary table 6 of the third exemplary embodiment includes only one mounting seat 21 and one spindle 22. The mounting seat 21 defines a space 210 that accommodates the spindle 22. The main driving motor 65 is also mounted to the mounting seat 21 and is directly connected to the spindle 22. The auxiliary driving motor 66 and the main driving motor 65 are disposed side by side. The first and second output shafts 651, 661 are parallel to and spaced apart from each other in the horizontal direction, and permit the first and second gears 671, 672 to be mounted thereon, respectively. As such, the auxiliary driving motor 66 drives rotation of the spindle 22 via the gear set 67.

In this embodiment, a fixture 29 is securely connected to the spindle 22 and stably holds one end of the work piece 100 (see FIG. 9). The CNC machine 1 is provided with a tailstock 27 that is spaced apart from the spindle 22 along the axis (X). The tailstock 27 includes a body 271 and a center 272 that is aligned with the axis (X) and that is movable back and forth along the axis (X) such that the center 272 can abut against the other end of the work piece 100 for securely holding the work piece 100 in place.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A rotary table adapted for use in a computer numerical control (CNC) machine that includes a fixture to drive rotation of the fixture, the fixture having opposite first and second ends, said rotary table comprising:
a first mounting seat defining a first space;
a first spindle disposed in said first space, rotatable about an axis, and securely connected to the first end of the fixture;
a second mounting seat spaced apart from said first mounting seat along the axis and defining a second space;
a second spindle disposed in said second space, rotatable about the axis, and securely connected to the second end of the fixture; and
a motor unit including a main driving motor that is directly connected to said first spindle so as to directly drive rotation of said first spindle, and an auxiliary driving motor that is for driving rotation of said second spindle,
said motor unit being operable in a first mode, where said main driving motor drives rotation of said first spindle and said auxiliary driving motor does not drive rotation of said second spindle, and in a second mode, where said auxiliary driving motor cooperates with said main driving motor to drive rotation of said first and second spindles so as to deliver a torque which is larger than that delivered in the first mode to the fixture to drive rotation of the fixture.

2. The rotary table as claimed in claim 1, further comprising a gear set disposed in said second space of said second mounting seat, and including a first gear that is securely connected to and co-rotatable with said second spindle, and a second gear that meshes with said first gear and that is driven by said auxiliary driving motor to enable rotation of said second spindle via said first gear.

3. The rotary table as claimed in claim 2, wherein a speed ratio of said second gear to said first gear is 1:1.

4. The rotary table as claimed in claim 1, wherein said auxiliary driving motor of said motor unit is directly connected to said second spindle so as to directly drive rotation of said second spindle.

5. The rotary table as claimed in claim 1, wherein said second spindle is formed with a through hole that extends along the axis and that is adapted for an electrical cable of the fixture to extend therethrough.

6. The rotary table as claimed in claim 1, further comprising a base on which said first and second mounting seats are fixedly disposed.

7. A rotary table adapted for use in a computer numerical control (CNC) machine that includes a fixture, said rotary table comprising:
a mounting seat defining a space;
a spindle disposed in said space, rotatable about an axis, and adapted to be securely connected to an end of the fixture; and
a motor unit including a main driving motor that is directly connected to said spindle so as to directly drive rotation of said spindle, and an auxiliary driving motor that is for driving rotation of said spindle,
said motor unit being operable in a first mode, where said main driving motor drives rotation of said spindle and said auxiliary driving motor does not drive rotation of said spindle, and in a second mode, where said auxiliary driving motor cooperates with said main driving motor to drive rotation of said spindle so as to deliver a torque which is larger than that delivered in the first mode to the fixture to drive rotation of the fixture.

8. The rotary table as claimed in claim 7, further comprising a gear set disposed in said space of said mounting seat, and including a first gear that is securely connected to and co-rotatable with said spindle, and a second gear that meshes with said first gear and that is driven by said auxiliary driving motor to enable rotation of said spindle via said first gear.

9. The rotary table as claimed in claim 8, wherein a speed ratio of said second gear to said first gear is 1:1.

10. The rotary table as claimed in claim 7, further comprising a base on which said mounting seat is fixedly disposed.
